(19) United States
(12) Patent Application Publication
(10) Pub. No.: US 2025/0074454 A1
(43) Pub. Date: Mar. 6, 2025

(54) AUTONOMOUS PREFERENCE SYSTEM FOR A VEHICLE

(71) Applicant: GM Global Technology Operations LLC, Detroit, MI (US)

(72) Inventors: Cindy Allen, Macomb, MI (US); Russell A. Patenaude, Macomb Township, MI (US); Evelyn J. Job, Allenton, MI (US)

(73) Assignee: GM Global Technology Operations LLC, Detroit, MI (US)

(21) Appl. No.: 18/459,229

(22) Filed: Aug. 31, 2023

(51) Int. Cl. B60W 60/00

(52) U.S. Cl. CPC B60W 60/001; B60W 2540/215; B60W 2556/10

(57) ABSTRACT

A vehicular autonomous preference system includes a plurality of sensors positioned within a cabin of a vehicle, and data processing hardware including a memory storing a user profile that includes user preferences and a trainable preference model that includes a model trainer. The data processing hardware is configured to execute the model trainer in response to sensor data received from one or more of the plurality of sensors to update the user preferences in the user profile. The data processing hardware is also configured to adjust ambient controls of the vehicle based on the trainable preference model and the updated user preferences.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to an autonomous preference system.

Vehicles often provide preset functions for a user. For example, the user may save preset seating functions that can automatically adjust in response to activation by the user. Vehicles also include heating and cooling controls that may be adjusted by the user to set an internal environment of the vehicle for comfort. Further, the user may adjust audio settings within the vehicle and select various playback options. Thus, while the user may select and adjust each of the in-vehicle settings, the vehicle typically is a passive component awaiting an input selection to be made.

### SUMMARY

In some aspects, an autonomous preference system for a vehicle includes a plurality of sensors positioned within a cabin of the vehicle and ambient controls of the vehicle electrically coupled to one or more of the plurality of sensors and configured to detect user inputs. The autonomous preference system also includes data processing hardware communicatively coupled with the plurality of sensors and the ambient controls. The data processing hardware includes a memory that stores a user profile that includes user preferences. The data processing hardware further includes a trainable preference model that includes a model trainer. The data processing hardware is configured to execute the model trainer in response to the detected user inputs received from the ambient controls and sensor data received from one or more of the plurality of sensors. The trainable preference model updates the user preferences in the user profile and is configured to adjust the ambient controls based on the trainable preference model and the updated user preferences.

In some examples, the trainable preference model may be a machine learning model. Optionally, the sensor data may include one or more of audio data, image data, and weight data. The data processing hardware may be configured to execute the model trainer in response to the audio data. In some instances, the user profile may include a routine, and the training preference model may be configured to generate the routine based on the ambient controls and the sensor data. The data processing hardware may be configured to execute one or more of the user preferences based on the routine. In other examples, the data processing hardware may include a navigation application including saved routes, and the model trainer may be configured to update the training preference model based on the saved routes.

In other aspects, a vehicular autonomous preference system includes a plurality of sensors positioned within a cabin of a vehicle, and data processing hardware including a memory that stores a user profile that includes user preferences and a trainable preference model that includes a model trainer. The data processing hardware is configured to execute the model trainer in response to sensor data received from one or more of the plurality of sensors to update the user preferences in the user profile. The data processing hardware is also configured to adjust ambient controls of the vehicle via the trainable preference model based on the updated user preferences.

In some configurations, the model trainer may be configured to identify a routine of a user in response to the sensor data and may be configured to update the trainable preference model and execute the routine. The routine may include one or more of the user preferences. The model trainer may be configured to update the routine during operation of the vehicle in response to at least one of user inputs and the sensor data. In some examples, the data processing hardware may be configured to identify a user based on the sensor data and may be configured to execute the user profile in response to the identified user. The data processing hardware may be configured to identify a new user based on the sensor data and the model trainer is configured to update the trainable preference model in response to the identified new user. Optionally, the vehicular autonomous preference system may include a user device communicatively coupled to the data processing hardware. The user device may be configured to transmit one or more of route data and calendar data, and the trainable preference model may be configured to generate a new user preference based on at least one of the route data and the calendar data.

In yet other aspects, an autonomous preference system includes a plurality of sensors within a cabin of a vehicle and data processing hardware including a memory that stores a plurality of user profiles that each respectively includes user preferences. The data processing hardware includes a trainable preference model that includes a model trainer, and the data processing hardware is configured to execute the model trainer in response to sensor data received from one or more of the plurality of sensors to update the user preferences in one or more of the plurality of user profiles. The trainable preference model is configured to select one of the user profiles based on the sensor data to execute the respective updated user preferences.

In some examples, the trainable preference model may be configured to autonomously learn new user preferences based on user inputs to the vehicle and the sensor data from the plurality of sensors. Optionally, the autonomous preference system may include a navigation application in communication with the data processing hardware, and the model trainer may be configured to update the trainable preference model with one or more repeated routes from the navigation application. The trainable preference model may be configured to select one or more of the user preferences based on an identified repeated route from the navigation application. In some instances, the plurality of sensors may include a weight sensor configured to detect a first weight and at least one second weight, and the trainable preference model may be configured to select a first user profile from the plurality of user profiles in response to receiving the first weight from the weight sensor. The data processing hardware may be configured to determine a time of day, and the trainable preference model may be configured to select respective user preferences from the one or more plurality of user profiles in response to the determined time of day.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle with occupants according to the present disclosure;

FIG. 2 is a functional block diagram of an autonomous preference system according to the present disclosure;

FIG. 3 is a partial perspective view of an interior cabin of a vehicle according to the present disclosure;

FIG. 4 is a flow diagram of an autonomous preference system according to the present disclosure;

FIG. 5 is a flow diagram of the autonomous preference system of FIG. 4 according to the present disclosure; and

FIG. 6 is a flow diagram of the autonomous preference system of FIG. 5 according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

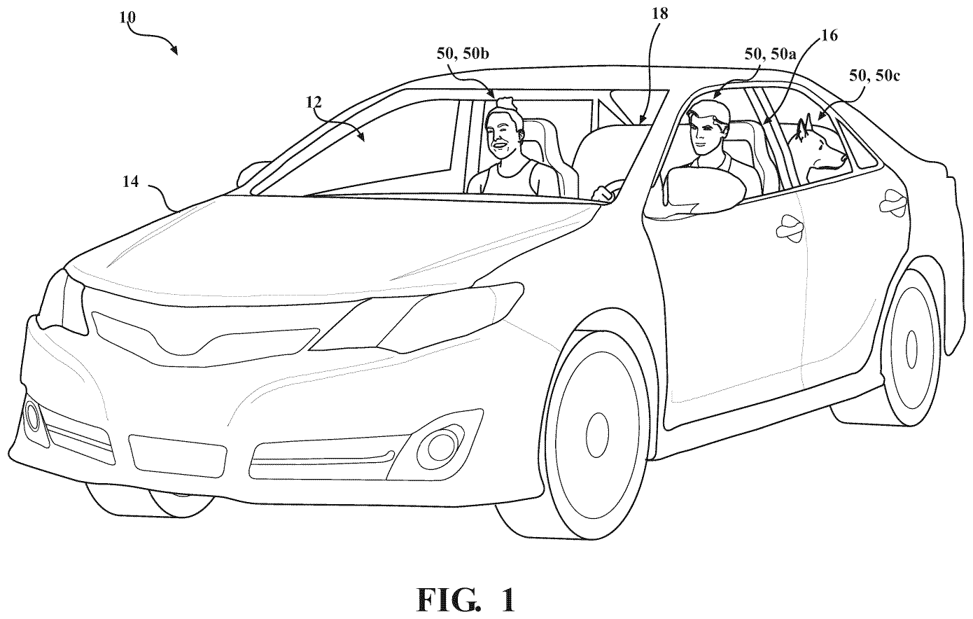

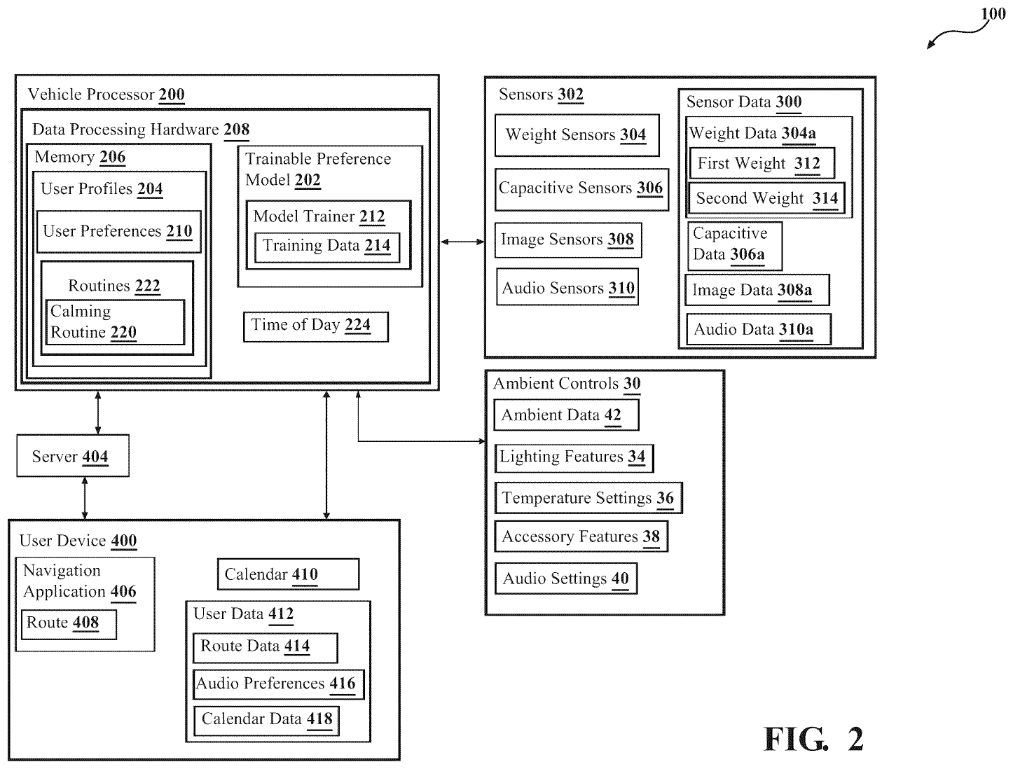

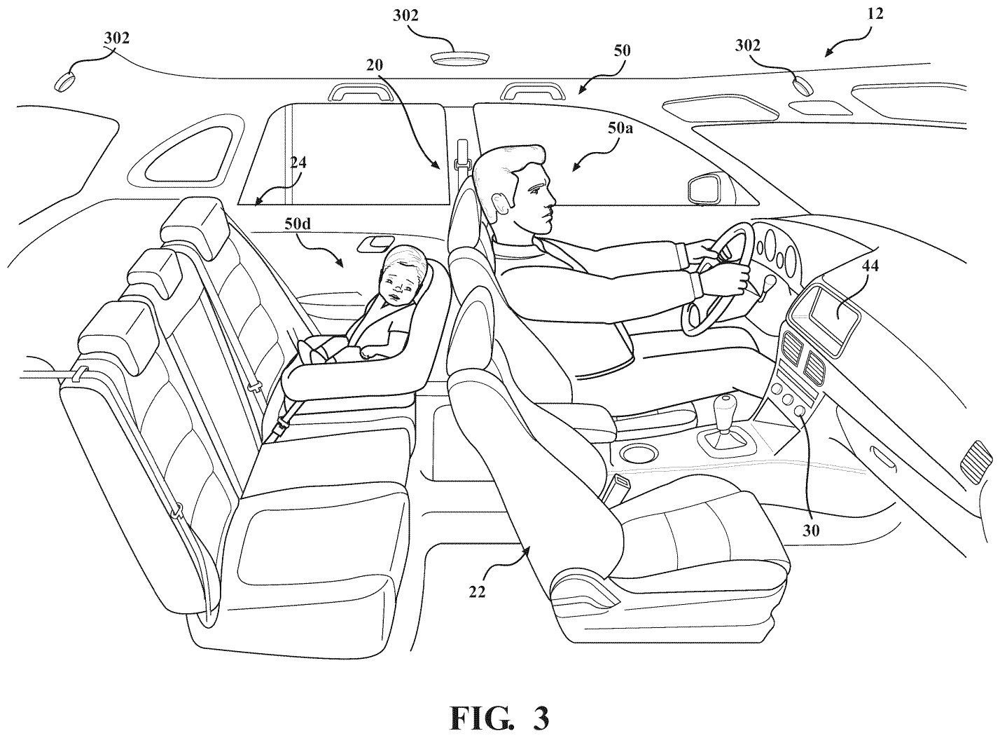

Referring to FIGS. 1-6, an autonomous preference system 100 for a vehicle 10 includes a vehicle processor 200 configured with a trainable preference model 202 and including one or more user profiles 204 stored in a memory 206 of the vehicle processor 200. The vehicle processor 200 is configured to monitor an interior cabin 12 of the vehicle 10. The vehicle 10 includes a vehicle body 14 with the interior cabin 12 therein. The interior cabin 12 defines a passenger compartment, which may include a first seating row 16 and a second seating row 18. In other examples, fewer or more seating rows may be included in the vehicle 10. The first seating row 16 includes a driver seat 20 and a passenger seat 22. The second seating row 18 may include rear passenger seats 24. As described below, the vehicle processor 200 is configured to receive a signal indicating occupancy of one or more of the seating rows 16, 18.

The interior cabin 12 also includes ambient controls 30 that control a plurality of outputs 32 within the interior cabin 12. For example, the ambient controls 30 may be directed to lighting features 34, temperature settings 36, accessory features 38, audio settings 40, and other ambient settings of the vehicle 10. The vehicle processor 200 may be communicatively coupled with the ambient controls 30 to collect ambient data 42. The ambient data 42 may collectively include data from each of the lighting features 34, the temperature settings 36, the accessory features 38, and the audio settings 40. The vehicle processor 200 may utilize the ambient data 42 in combination with the trainable preference model 202, as described below. For example, the vehicle processor 200 may utilize the ambient controls 30 to update one or both of the trainable preference model 202 and the user profiles 204.

Referring now to FIGS. 1-3, the vehicle processor 200 includes data processing hardware 208 configured to execute the trainable preference model 202 and execute user preferences 210 associated with each respective user profile 204. The trainable preference model 202 includes a model trainer 212 that is configured to obtain training data 214 for training the trainable preference model 202. The trainable preference model 202 is configured as a machine learning model 202, such that the model trainer 212 is configured to train the machine learning model 202 based on the training data 214. The model trainer 212 may retrieve the training data 214 from, for example, the user profiles 204. The training data 214 includes, but is not limited to, the user preferences 210. The training data 214 may also include any type of data that the trainable preference model 202 is trained to receive (e.g., text, images, audio, etc.). For example, the training data 214 may include sensor data 300 from a plurality of sensors 302 disposed within the interior cabin 12 of the vehicle 10 and the ambient data 42 from the ambient controls 30. The trainable preference model 202 is trained to predict future user preferences 210 based on the training data 214. For example, the model trainer 212 may utilize the sensor data 300 to update the user preferences 210.

The plurality of sensors 302 are disposed in various locations within the interior cabin 12. The sensors 302 may include, but are not limited to, weight sensors 304, capacitive sensors 306, image sensors 308, and audio sensors 310. For example, a camera or other imager 308 may be positioned within the interior cabin 12 proximate to the driver seat 20, and an additional imager 308 may be positioned proximate to the rear passenger seats 24 to monitor occupants 50 positioned in one or more of the rear passenger seats 24. The sensor data 300 collectively refers to weight data 304a, capacitive data 306a, image data 308a, and audio data 310a. For example, the image data may include image recognition data, image dimension data, and/or image mapping data. In some examples, the weight sensors 304 may be positioned within each of the driver seat 20, the passenger seat 22, and the rear passenger seats 24. The weight sensors 304 are configured to detect a weight positioned on each respective seat 20-24 and to communicate the weight data 304a with the vehicle processor 200 for analysis. Accordingly, the weight sensors 304 are configured to provide differentiating data to assist in identifying one occupant 50 compared to another.

The audio data 310a may be collected from the audio sensors 310 detecting the occupants 50 within the vehicle 10. The audio sensors 310 may include one or more microphones positioned within the interior cabin 12 to collect the audio data 310a. For example, the audio data 310a may include speaking, crying, barking, whining, and other occupant noises. As described below, the vehicle processor 200 receives the audio data 310a and may execute the trainable preference model 202 in response to the audio data 310a. The capacitive data 306a may include inputs from the occupant 50 on a display console 44 of the vehicle 10. The model trainer 212 may train the trainable preference model 210 with the capacitive data 306a to learn the input selections of a respective occupant 50. The trainable preference model 210 may first identify the occupant 50 based on one or more of the weight data 304a, the image data 308a, and the audio data 310a and may then execute functions of the vehicle 10 corresponding to the capacitive data 306a.

Similarly, the vehicle processor 200 receives the image data 308a, which may be utilized in combination with the trainable preference model 202. The image data 308a may include, but is not limited to, images of the occupants 50 within the vehicle 10. While the image data 308a may confirm a location of the occupants within the vehicle 10, the image data 308a may also be utilized to monitor behaviors and actions within the vehicle 10. The trainable preference model 202 may be configured to execute user preferences 210 in response to the image data 308a, described in more detail below.

Referring still to FIGS. 1-3, the vehicle processor 200 may be communicatively coupled to a user device 400 via a wired or wireless connection. For example, the user device 400 may be coupled to the display console 44 of the vehicle 10. In some examples, the user device 400 may be communicatively coupled to the vehicle processor 200 via a network 404 that assists in transmitting signals between the user device 400 and the vehicle processor 200. The user device 400 includes a navigation application 406 that is configured to provide a route 408 for the user. The user may save or otherwise store routes 408 within the navigation application 406, and the navigation application 406 may be configured to detect or otherwise identify repeated routes 408 based on regularly visited locations. The repeated routes 408 may also be stored within the navigation application 406, and all of the routes 408 may be communicated with the vehicle processor 200 to be stored in the respective user profile 204.

The user device 400 may also be configured with a calendar 410 that may include appointments, meetings, and other scheduled events. As described herein, the vehicle processor 200 may gather user data 412 from the user device 400, and the model trainer 212 may utilize the user data 412 as training data 214 for the trainable preference model 202. The user data 412 includes, but is not limited to, route data 414, calendar data 416, and audio preferences 418. For example, the route data 414 includes the routes 408, mentioned above, and the audio preferences 418 may include, but are not limited to, music selections, audiobook selections, podcast selections, and other applications or features of the user device 400 that may be selected by the user to output audio within the interior cabin 12 of the vehicle 10.

It is also contemplated that, in some examples, the user may input the user preferences 210 via the user device 400. The input user preferences 210 may then be communicated with the vehicle processor 200 and stored in the user profile 204. The user preferences 210, as mentioned above, may include the user data 412 and may be communicated with the trainable preference model 202. The trainable preference model 202 may continuously update the user preferences 210 regardless of whether the user preferences 210 are input by the user via the user device 400, the display console 44, and/or added by the vehicle processor 200 over a period of time.

With further reference to FIGS. 1-3, examples pertaining to the autonomous preference system 100 are described. In some examples, the occupants 50 of the vehicle 10 may include a first occupant 50a, a second occupant 50b, and an animal occupant 50c. In other examples, the occupants 50 of the vehicle 10 may include the first occupant 50a, the second occupant 50b, and a child occupant 50d. The autonomous preference system 100 is configured to detect and identify the occupants 50 using the trainable preference model 202 and based on the user profiles 204 and saved user preferences 210. It is contemplated that, upon first use, the occupants 50 may input information into the display console 44 or via the user device 400 to set up each respective user profile 204. Additionally or alternatively, the model trainer 212 may, over time, train the trainable preference model 202 and generate each respective user profile 204 based on the training data 214.

For example, the trainable preference model 202 may generate the user preferences 210 based on the sensor data 300 and the ambient data 42 received by the data processing hardware 208 and the model trainer 212. The trainable preference model 202 may identify various user preferences 210 and execute the user preferences 210 automatically in response to a detected user. Thus, the trainable preference model 202 is configured to autonomously execute the user preferences 210 based on the detected or otherwise identified user 50.

The data processing hardware 208 is configured to identify the user based on the sensor data 300 and is configured to execute the user profile 204 in response to the identified user. In other examples, the data processing hardware 208 may identify a new user based on the sensor data 300. The model trainer 212 is configured to update the trainable preference model 202 in response to the identified new user. For example, when a new user is identified, the data processing hardware 208 generates a new user profile 204. The model trainer 212 may then train the trainable preference model 202 with the new user profile 204. If the new user profile 204 does not contain user preferences 210, then one or both of the data processing hardware 208 and the trainable preference model 202 may update the new user profile 204 as data is collected by the vehicle processor 200.

For example, the vehicle processor 200 may collect the audio data 310a from within the interior cabin 12. The data processing hardware 208 may execute the model trainer 212 in response to the audio data 310a to execute one or more of the user preferences 210. For example, the audio data 310a may be the child occupant 50d crying in the rear passenger seat 24. The audio data 310a may include the crying, and the trainable preference model 202 may identify one of the user preferences 210 that corresponds to a calming routine 220. For example, the calming routine 220 may include the trainable preference model 202 executing the audio preferences 418 associated with the calming routine 220. In the example of the child occupant 50d crying, the trainable preference model 202 may select the audio preferences 418 of the calming routine 220 to relax or otherwise calm the child occupant 50d.

In some instances, the trainable preference model 202 may utilize the image data 308a to execute one or more of the user preferences 210. For example, the image data 308a may include content of the animal occupant 50c chewing on an object within the vehicle 10 that the first occupant 50a may otherwise choose to remain untouched. The trainable preference model 202 may execute an alert or other notification to notify the first occupant 50a to the situation. It is also contemplated that the trainable preference model 202 may output audio preferences 418 of the user preferences 210 that may distract the animal occupant 50d from the action. In another example, the image data 308a may be used to detect that the occupant 50, including both the animal occupant 50d and the child occupant 50c, that may be out of view of the driver occupant 50 is experiencing discomfort or otherwise may benefit from the calming routine 220. The trainable preference model 202 is configured to execute the calming routine 220 and/or notify the driver occupant 50 of the state of the occupants 50 that are out of view. The trainable preference model 202 is configured to execute other user preferences 210, such that the calming routine 220 is one example of many user preferences 210.

For example, the user profile 204 may also include routines 222. The routines 222 may be generated by the trainable preference model 202 based on one or more of the sensor data 300, the ambient data 42, and the user data 412. The routines 222 may be configured to execute the user preferences 210, such that the data processing hardware 208 may execute one or more user preferences 210 in response to a selection of the routine 222. For example, the routines 222 may include, but are not limited to, a morning routine, an afternoon routine, and an evening routine. The model trainer 212 may identify one of the routines 222 of the user in response to the sensor data 300. The model trainer 212 may, based on the sensor data 300, update the trainable preference model 202 to include the routine 222 and to execute the routine 222. During operation of the vehicle 10, the model trainer 212 may continuously update the trainable preference model 202, which may update the routine 222 in response to at least one of user inputs and the sensor data 300.

The model trainer 212 is configured to continuously and autonomously update the routines 222. For example, the model trainer 212 receives the various data from the sensors 302, the ambient controls 30, and the user device 400 continuously during operation of the vehicle 10. The model trainer 212 uses the data to train the trainable preference model 202 to, ultimately, execute the user preferences 210 and the routines 222 independent of activation by a user input. Rather, the trainable preference model 202 is a machine learning model that autonomously adapts and executes the user preferences 210 and/or routines 222 based on the received data.

In some examples, the received data may include the route data 414. The route data 414, as mentioned above, may be input by the user or saved as a route 408 within the navigation application 406. In either example, the model trainer 212 may train the trainable preference model 202 to recognize the route 408. For example, the occupant 50 may operate the vehicle 10 in a direction associated with the route 408, and the trainable preference model 202 may autonomously execute user preferences 210 associated with the route 408. In some examples, the route 408 may direct the vehicle 10 toward a sporting event, which the trainable preference model 202 may identify as being associated with upbeat music from the audio preferences 418.

The data processing hardware 208 may also be configured to identify repeated routes 408 from the navigation application 406 and the user device 400. The model trainer 212 updates the trainable preference model 202 in response to the repeated route 408 from the navigation application 406. In response to the identified repeated route 408, the trainable preference model 202 may select one or more of the user preferences 210.

The trainable preference model 202 may further confirm the route 408 and selection of user preferences 210 with the calendar data 416. For example, the calendar data 416 may include a scheduled event indicating the sporting event. Thus, the trainable preference model 202 can confirm the context of the route 408 prior to execution of the user preferences 210. It is also contemplated that the model trainer 212 may identify a new route 408 based on the route data 414. For example, the user may start a new class or regularly scheduled meeting that was not previously identified as being a saved route 408. Thus, the model trainer 212 may, in response to the route data 414 and the calendar data 416, generate a new user preference 210. It is contemplated that the occupant 50 may adjust the various features of the vehicle 10, such as the audio output, that was otherwise selected by the trainable preference model 202. The model trainer 212 is configured to train and update the trainable preference model 202 in response to adjustments made by the occupant 50 to subsequently learn the new user preferences 210.

In other examples, the new user preferences 210 may be learned by the model trainer 212 in response to a user input into the vehicle 10 and the sensor data 300 from the sensors 302. Further, the data processing hardware 208, as generally noted above, may be configured to determine a time of day 224. The trainable preference model 202 may select one or more user preferences 210 from the user profile 204. The trainable preference model 202 may utilize the determination of the time of day 224 to further select the routine 222, mentioned above.

As mentioned above, the data processing hardware 208 is configured to receive the weight data 304a from the weight sensor 304, which may be stored in respective user profiles 204. In some instances, the weight sensor 304 may detect a first weight 312 and at least one second weight 314. The first weight 312 may be associated with the first occupant 50a, and the at least one second weight 314 may be associated with the second occupant 50b. Additionally or alternatively, the second weight 314 may be associated with the animal occupant 50c and/or the child occupant 50d, such that the second weight 314 is distinguishable from the first weight 312.

While the first occupant 50a is illustrated as a driver, the autonomous preference system 100 is configured to identify repositioning of the occupants 50 within the vehicle 10. For example, the trainable preference model 202 may identify the difference between the first weight 312 and the second weight 314 and compare the detected weights 312, 314 with the stored user profiles 204. The trainable preference model 202 may further utilize context from the sensor data 300 and ambient data 42.

The user preferences 210 associated with the first occupant 50a may be adjusted based on a location or position of the first occupant 50a within the cabin 12. For example, the trainable preference model 202 may identify that, while the first occupant 50a had previously been located in the driver seat 20, the first occupant 50a moved to the passenger seat 22. In some examples, the trainable preference model 202 identifies the change of location of the first occupant 50a based on the weight data 304a collected by from the weight sensor 304. The weight data 304a may indicate that the first weight 312, which was previously detected in the driver seat 20, is being detected in the passenger seat 22. In response, the trainable preference model 202 may identify the user preferences for the first occupant 50a and execute the user preferences 210 relative to the passenger seat 22. The trainable preference model 202 may confirm the location change of the first occupant 50a by comparing the first weight 312 detected in the passenger seat 22 with the second weight 314 detected in the driver seat 20.

The trainable preference model 202 may execute the user preferences 210 associated with the first occupant 50a once the first occupant 50a is identified. For example, the trainable preference model 202 may adjust the ambient controls 30 based on the ambient data 42 associated with the user profile 204 of the first occupant 50a. For example, the trainable preference model 202 may adjust the temperature settings 36 based on the temperature settings 36 stored in the respective user profile 204 for the first occupant 50a. The adjustment of the user preferences 210 may occur regardless of the position of the occupant 50 within the vehicle 10.

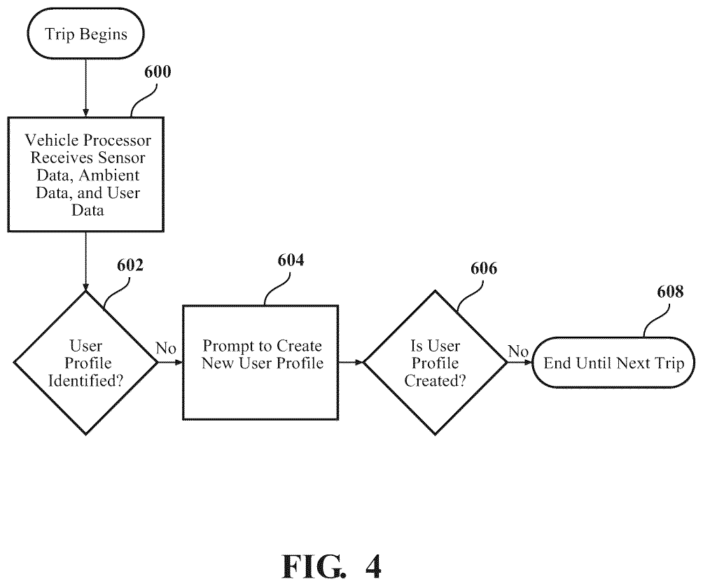

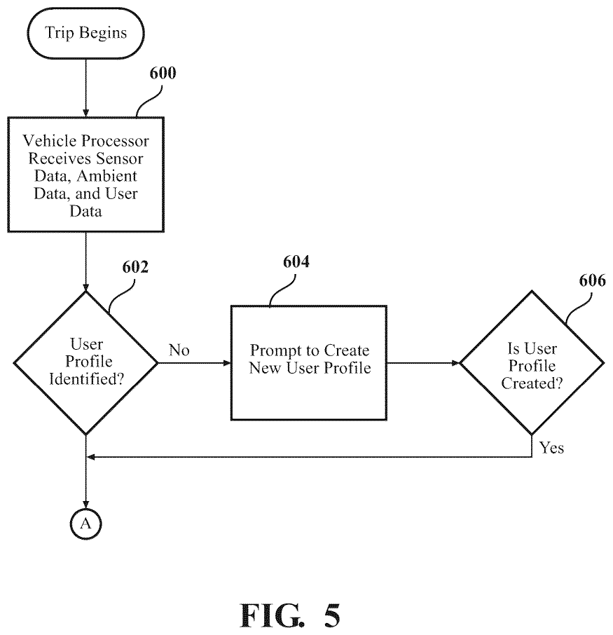

With reference again to FIGS. 1-6, flow diagrams of the autonomous preference system 100 is outlined in FIGS. 4-6. At an initial step 600, the vehicle processor 200 receives the sensor data 300, the ambient data 42, and the user data 412 to classify the occupants 50. The trainable preference model 202 determines, at 602, whether a user profile 204 is stored in the memory 206. If no user profile 204 is identified, then the trainable preference model 202, at 604, prompts the occupant 50 to create a user profile 204. The trainable preference model 202 identifies whether the occupant 50 chose to create a user profile 204 at 606. If the occupant 50 dismisses the prompt, then the trainable preference model 202, at 608 stops the creation of a new user profile 204 until the next route 408. FIG. 5 illustrates the occupant 50 electing to create a user profile 204.

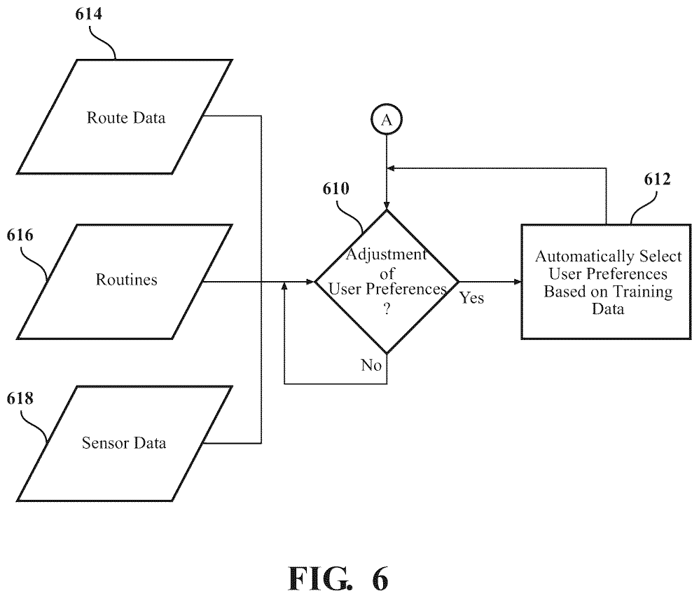

FIG. 6 illustrates the continued flow diagram. At 610, the trainable preference model 202 may suggest adjustment of user preferences 210 based on the user profile 204. If the trainable preference model 202 suggests adjustment based on the occupant 50, then the trainable preference model 202 automatically selects, at 612, user preferences 210 based on the training data 214. If the trainable preference model 202 does not suggest adjustment, then the trainable preference model 202, at 614-618, may evaluate one or more of the route data 414, the routines 222, and the sensor data 300 for occupant 50 recognition.

Referring again to FIGS. 1-6, the autonomous preference system 100 is configured to execute user preferences 210 independent of user input or other adjustment by the occupant 50. The autonomous preference system 100 utilizes the model trainer 212 to continuously update and train the trainable preference model 202. The trainable preference model 202 utilizes machine learning to continuously revise the execution of the user preferences 210 and update the user preferences 210 in response to the sensor data 300 and the ambient data 42. Thus, the autonomous preference system 100 advantageously adjusts to the user preferences 210 based on an intelligent trainable preference model 202 to continuously adapt, monitor, and provide an improved user experience.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An autonomous preference system for a vehicle, the autonomous preference system comprising:
a plurality of sensors positioned within a cabin of the vehicle;
ambient controls of the vehicle electrically coupled to one or more of the plurality of sensors and configured to detect user inputs; and
data processing hardware communicatively coupled with the plurality of sensors and the ambient controls and including a memory storing a user profile that includes user preferences and further including a trainable preference model that includes a model trainer, the data processing hardware configured to execute the model trainer in response to the detected user inputs received from the ambient controls and sensor data received from one or more of the plurality of sensors to update the user preferences in the user profile and configured to adjust the ambient controls based on the trainable preference model and the updated user preferences.

2. The autonomous preference system of claim 1, wherein the trainable preference model is a machine learning model.

3. The autonomous preference system of claim 1, wherein the sensor data includes one or more of audio data, image data, and weight data.

4. The autonomous preference system of claim 3, wherein the data processing hardware is configured to execute the model trainer in response to the audio data.

5. The autonomous preference system of claim 1, wherein the user profile includes a routine and the training preference model is configured to generate the routine based on the ambient controls and the sensor data.

6. The autonomous preference system of claim 5, wherein the data processing hardware is configured to execute one or more of the user preferences based on the routine.

7. The autonomous preference system of claim 1, wherein the data processing hardware includes a navigation application, the model trainer configured to update the trainable preference model with one or more anticipated destinations from the navigation application.

8. A vehicular autonomous preference system, comprising:
a plurality of sensors positioned within a cabin of a vehicle; and
data processing hardware including a memory storing a user profile that includes user preferences and a trainable preference model that includes a model trainer, the data processing hardware configured to execute the model trainer in response to sensor data received from one or more of the plurality of sensors to update the user preferences in the user profile and configured to adjust ambient controls of the vehicle via the trainable preference model based on the updated user preferences.

9. The vehicular autonomous preference system of claim 8, wherein the model trainer is configured to identify a routine of a user in response to the sensor data and is configured to update the trainable preference model and execute the routine.

10. The vehicular autonomous preference system of claim 9, wherein the routine includes one or more of the user preferences.

11. The vehicular autonomous preference system of claim 9, wherein the model trainer is configured to update the routine during operation of the vehicle in response to at least one of user inputs and the sensor data.

12. The vehicular autonomous preference system of claim 8, wherein the data processing hardware is configured to identify a user based on the sensor data and is configured to execute the user profile in response to the identified user.

13. The vehicular autonomous preference system of claim 12, wherein the data processing hardware is configured to identify a new user based on the sensor data and the model trainer is configured to update the trainable preference model in response to the identified new user.

14. The vehicular autonomous preference system of claim 8, further including a user device communicatively coupled to the data processing hardware and configured to transmit one or more of route data and calendar data, the trainable preference model configured to generate a new user preference based on at least one of the route data and the calendar data.

15. An autonomous preference system, comprising:
a plurality of sensors positioned within a cabin of a vehicle; and
data processing hardware including a memory storing a plurality of user profiles that each respectively include user preferences and including a trainable preference model that includes a model trainer, the data processing hardware configured to execute the model trainer in response to sensor data received from one or more of the plurality of sensors to update the user preferences in one or more of the plurality of user profiles and configured to select one of the user profiles based on the sensor data to execute the respective updated user preferences.

16. The autonomous preference system of claim 15, wherein the trainable preference model is configured to autonomously learn new user preferences based on user inputs to the vehicle and the sensor data from the plurality of sensors.

17. The autonomous preference system of claim 15, further including a navigation application in communication with the data processing hardware, the model trainer configured to update the trainable preference model with one or more anticipated destinations from the navigation application.

18. The autonomous preference system of claim 17, wherein the trainable preference model is configured to select one or more of the user preferences based on an identified anticipated destination from the navigation application.

19. The autonomous preference system of claim 15, wherein the plurality of sensors are configured to detect first sensor data and at least one second sensor data, the trainable preference model configured to select a first user profile from the plurality of user profiles in response to receiving the first sensor from the plurality of sensors.

20. The autonomous preference system of claim 19, wherein the data processing hardware is configured to determine a time of day and the trainable preference model is configured to select respective user preferences from the one or more plurality of user profiles in response to the determined time of day.
